(19) United States
(12) Patent Application Publication
(10) Pub. No.: US 2013/0197817 A1
(43) Pub. Date: Aug. 1, 2013

(54) METHOD OF ASSESSING STABILITY OF A CHEMICAL SAMPLE AND IDENTIFYING POSITIONAL VARIATIONS IN A CHEMICAL STRUCTURE

(71) Applicant: The Trustees of Columbia University in the City of New York, New York, NY (US)

(72) Inventor: Simon Billinge, Brooklyn, NY (US)

(73) Assignee: The Trustees of Columbia University in the City of New York, New York, NY (US)

(21) Appl. No.: 13/800,519

(22) Filed: Mar. 13, 2013

Related U.S. Application Data
(63) Continuation-in-part of application No. 12/802,064, filed on May 28, 2010.
Application No. 12/802,064 is a continuation-in-part of application No. 13/310,683, filed on Dec. 2, 2011.
Application No. 13/310,683 is a continuation of application No. PCT/US2010/001567, filed on May 28, 2010.
Application No. PCT/US2010/001567 is a continuation-in-part of application No. 12/802,064, filed on May 28, 2010.
(60) Provisional application No. 61/217,785, filed on Jun. 3, 2009.
(60) Provisional application No. 61/271,688, filed on Jul. 24, 2009.

(30) Foreign Application Priority Data
May 28, 2010 (US) PCT/US2010/001567

(51) Int. Cl. G06F 19/00

(52) U.S. Cl. CPC G06F 19/70
USPC 702/28

(57) ABSTRACT

Methods of characterizing a chemical sample, and in particular, assessing stability of a sample, identifying trace amounts of an amorphous phase in a sample, and identifying structural variations in the internal structure of a sample.

### CROSS-REFERENCE TO RELATED APPLICATIONS

This application is a continuation-in-part of U.S. patent application Ser. No. 13/310,683 filed Dec. 2, 2011, and U.S. patent application Ser. No. 12/802,064 both claiming priority to U.S. Provisional Patent Application Ser. No. 61/217,785, filed Jun. 3, 2009 and U.S. Provisional Patent Application Ser. No. 61/271,688, filed Jul. 24, 2009. The entire contents of the above-mentioned applications are hereby incorporated by reference as if recited in full herein.

### FIELD

Methods are described for characterizing the internal structure, structural phases, and assessing the stability of a material using x-ray total scattering analysis techniques.

### BACKGROUND

The physical and chemical properties of a material are determined by different factors, including its chemical composition, the chemical structure of its molecules, and how its molecules are held together. Thus, knowledge of a material's atomic structure is a prerequisite to understanding the properties of the material in general. Even when individual molecules of two materials have the same chemical composition, the properties, e.g., crystal lattice energy, melting point, chemical reactivity, density, solubility, and/or stability of the two materials may widely vary. These differences may depend on, for example, the internal structure of the materials, and/or how the atoms or molecules are arranged or packed over a long range order.

In the pharmaceutical industry, drug properties have an important impact on the performance, bioavailability, and/or stability of drugs. Currently, most drugs are delivered as crystalline powders. Crystalline powders, however, often have poor solubility. Poorly water-soluble drug candidates often present formulators with considerable technical challenges. Generally, the absorption of such drug compounds when administered in the crystalline state to the gastrointestinal system is dissolution rate-limited. Thus, there is a growing interest in developing drugs in non-crystalline forms, such as an amorphous (a-) form or a nanocrystalline (n-) form, which are generally more soluble than crystalline drugs. One drawback to amorphous and nanocrystalline drugs is that they are generally less stable than crystalline drug forms. Amorphous and nanocrystalline drugs sometimes transform or crystallize into a more stable form during manufacturing, packaging, distribution, or storage. This transformation may lead to unexpected changes in the behavior or properties of the drug, which can have considerable formulation, therapeutic, and/or safety implications. This presents a major concern for both the pharmaceutical industry, as well as the regulatory agencies that approve drugs for market.

X-ray powder diffraction (XRPD) is routinely used by pharmaceutical scientists to identify the internal structural form of crystalline drugs. Although single crystal studies are often preferred for structure solution, quantitative analysis of XRPD patterns can also yield the atomic arrangement and molecular packing of organic material (1). XRPD is often the method of choice for refining previously solved structures using the Rietveld method (2, 3). XRPD is usually highly successful in cases where single crystals are not available, and when studying powdered samples, such as phase analysis of a pellet. XRPD may be indispensable in pharmaceutical research and in industrial communities. However, XRPD as practiced in the art has significant and important limitations when used to characterize nanoscale features of organic materials or drugs. Its limitations make it inappropriate for the characterization or identification of drugs at the nanoscale, and inappropriate for characterizing organic materials or drugs with multiple or different amorphous phases and certain nanocrystalline phases. Although crystallography is powerful with larger crystalline structures, it loses its power for structures at the nanoscale. This is sometimes referred to as the nanostructure problem (4). At the nanoscale, conventional XRPD patterns become broad and featureless and are not useful for differentiating between different local molecular packing arrangements within a sample material. Thus, XRPD patterns are not reliable for nanoscale structures, and cannot reliably be used for the identification of the structural phases or a full quantitative structural characterization, other than perhaps a mere generic description that the structure is “amorphous” or “x-ray amorphous” (20). It has recently been suggested that Fourier transforming the conventional XRPD data to obtain a pair distribution function (PDF) (5, 6) allows the extraction of more information about the structures (7). However, there are no clear examples that this method has successfully been applied to obtain a full quantitative structural characterization of organic material. The reason is that the information content in conventional XRPD data from “x-ray amorphous” samples is very limited, and that the Fourier transformation of the data to obtain the PDF, does not add any information. Therefore, the information content in the PDF derived from conventional XRPD data is similarly limited.

Currently, there is no reliable method for the structural identification and characterization of amorphous and certain nanocrystalline drugs. Moreover, certain crystalline drugs with significant nano-range structural distortions that are not reflected in the average structure cannot reliably be studied using conventional XRPD methods. Thus, there is an important and unsolved problem in nanoscience and in the characterization of the nanocrystalline and amorphous forms of drugs and other organic materials.

### SUMMARY

In one aspect, the disclosed subject matter provides a method for assessing the stability of a chemical sample. The chemical sample, for example, can be a chemical compound, such as a drug, contrast agent, imaging agent, or other chemical material. The chemical sample can also be a drug product, or mixture of components. The stability includes shelf life stability of the chemical sample, phase stability, or process history stability.

In accordance with the method of this embodiment, the chemical sample is subjected to x-ray total scattering to create a first dataset. The chemical sample can be stored or processed (or both) for a period of time under a set of conditions such as time, temperature, pressure, humidity, illumination to obtain a potentially modified organic chemical compound. The potentially modified chemical sample is subjected to x-ray total scattering analysis to obtain a second dataset. The period of time, for example, can be any period of time, such as weekly, monthly, 3 months, 6 months, 12 months, or 24 months. Periodic stability assessments over time can be made to determine whether the chemical sample changes over time. This is particularly important in cases where the chemical sample is an organic drug.

The first and second data sets, in some instances, are atomic pair distribution functions or mathematically related functions. In one embodiment, the first and second datasets are reduced structure functions. A comparison is made between the first and second data sets to assess or determine changes in the stability of the chemical sample. In this manner, a determination can be made regarding any changes in the internal structure of the chemical sample. For example, it can be determined whether the sample degrades under certain conditions. Additionally, it can be determined whether the sample exhibits a structural phase change under certain conditions. The method can be particularly useful in assessing the stability of drugs at the nanometer scale. All of these assessments are particularly important during drug development and characterization of drugs for the drug approval process.

In another aspect of the disclosed subject matter, the internal structure of an organic chemical sample can be reliably determined. In this regard, the organic chemical sample is subjected to x-ray total scattering analysis to define a first dataset. The dataset is transformed by at least one of reduced total scattering structure function F(Q) or an experimentally derived atomic pair distribution function (PDF), or mathematically related functions thereto. The internal structure of the organic chemical sample is determined by analyzing the datasets. In this manner, the organic chemical sample can be fingerprinted, when the F(Q) is from a known material. In another embodiment, the organic chemical sample is modeled, when the F(Q) is calculated from a model.

The organic chemical sample may comprises one or more structural phases or forms within its internal structure. The method described herein is useful for identifying those structural phases and determining the relative abundance of one or more structural phases. For example, the one or more structural phases may include nanocrystalline, amorphous, crystalline, or distorted crystalline regions. In one embodiment, the internal structure or the existence of one or more structural phases cannot be accurately or reliably determined by conventional XRPD techniques. For example, conventional XRPD techniques sometimes indicate that a sample is x-ray amorphous, i.e., exhibits broad features in the conventional XRPD pattern, however, the sample is really nanocrystalline and not amorphous. Accordingly, conventional XRPD techniques are not reliable for the characterization of chemical compounds, and in particular, pharmaceuticals at the nanoscale. The method described herein can reliably characterize an organic sample.

The organic chemical sample, for example, can be a drug having a long range order less than 100 nm. For example, the long range order may be about: 5 nm to 20 nm, 25 to 50 nm, or 50 nm to 100 nm. Notably, the shorter the long range order the more difficult it is for conventional XRPD techniques to reliably characterize the internal structure of an organic sample. The organic sample can be a dosage form, such as a compressed pill, solution, liquid, gel, polymer matrix, or suspension.

The method described can reliably characterize the internal structure and also identify structural phases within the sample; as the sample may include multiple structural phases. In one aspect, the method characterizes a sample to determine the proportion of crystalline, amorphous, nanocrystalline phases within the sample. Thus, in another aspect, the method can detect variations in the internal structure of the organic chemical sample, such as a drug or composition of the dosage form.

In another aspect, the method can be used to identify components of a mixture by subjecting the mixture to a x-ray total scattering analysis to define a first dataset, transforming the dataset to a reduced total scattering structure function F(Q), PDF, or a mathematically related function, determining at least one component of the mixture by analysis of the dataset and analyzing the dataset to identify any amorphous, nanocrystalline, or crystalline constituents in the mixture. The mixture can be a pharmaceutical formulation that comprises for example, one or more drugs. The mixture can be a gel, liquid, suspension, or a polymer matrix with the drug dispersed therein.

In another aspect, the method can be used to assess the positional variations in the structure or composition of a chemical sample by obtaining a first x-ray total scattering analysis dataset from a first position of the sample, obtaining a second x-ray total scattering analysis dataset from a second position within the chemical sample and comparing the datasets to assess the positional variations within the sample. The positional variations can comprises variations in structural composition. The method can detect amorphous form or phase coexisting with a crystalline form or phase. In one regard, the amorphous form is in trace amounts of the sample. Thus, the method can be useful in identifying trace amounts of an amorphous form of a predominantly crystalline material sample.

In another aspect, a method is provided for comparing solid small molecule organic materials. This method comprises (a) subjecting a first solid small molecule organic material to x-ray total scattering analysis and collecting a first set of data generated thereby; (b) subjecting a second solid small molecule organic material to x-ray total scattering analysis and collecting a second set of data generated thereby; (c) optionally, mathematically transforming the first set of generated data to provide a first refined set of data and mathematically transforming the second set of generated data to provide a second refined set of data; and (d) comparing the first set of generated data and the second set of generated data or the first set of refined data and the second set of refined data to determine a difference or a similarity therein, wherein a similarity represents that the first and the second solid small molecule organic material have similar structures, and a difference represents that the first and the second solid small molecule organic material have different structures.

A further exemplary embodiment of the subject matter is a method of characterizing a material. The method comprises (a) subjecting the nanocrystalline solid small molecule organic material to x-ray total scattering analysis and collecting a first set of data generated thereby; (b) subjecting a crystalline solid small molecule organic material to x-ray total scattering analysis and collecting a second set of data generated thereby, wherein the crystalline solid small molecule organic material has the same molecular structure as the nanocrystalline solid small molecule organic material; and (c) applying a mathematical modulation to the first set of generated data, or the second set of generated data, or both the first set and the second set of generated data to determine the structure of the nanocrystalline material. If, after appropriate mathematical modulation, the two datasets are sufficiently similar, the nanoscale crystal structure of the nanocrystalline solid is the same as the crystal structure of the crystalline solid. In another aspect, the method can be used to characterize a material. In one embodiment of this aspect, the material is subjected to x-ray total scattering analysis, the resulting dataset is transformed to a reduced total scattering structure function, the data is analyzed to characterize the material as crystalline, amorphous, or nanocrystalline, and the proportion of crystalline, amorphous, or nanocrystalline components in the material is then determined. In a further embodiment, the material may contain various distinct crystalline, nanocrystalline, or amorphous forms. In a still further embodiment, the method includes distinguishing the distinct crystalline, nanocrystalline, or amorphous forms.

In another aspect, the method can be used to quantify constituents of a mixture. In one embodiment, the mixture includes different active pharmaceutical ingredients. In another embodiment, the mixture includes one or more active pharmaceutical ingredients and one or more excipients. Further, the one or more active pharmaceutical ingredients or excipients are amorphous or nanocrystalline. Thus, the method is sufficiently sensitive to not only identify true amorphous and nanocrystalline compounds in a mixture, but also to quantify them. In another aspect, the method can identify amorphous API components coexisting with crystalline forms.

### BRIEF DESCRIPTION OF THE DRAWINGS

FIG. 1 compares data collected from different x-ray analysis of different forms of carbamazepine (CBZ). The top row of panels, (FIGS. 1(a), 1(d), 1(g), and 1(j)) contain patterns from CBZ in the beta crystalline form, the middle row (FIGS. 1(b), 1(e), 1(h), and 1(k)) in the non-crystalline form, and the bottom row (FIGS. 1(c), 1(f), 1(i), and 1(l)) in the gamma crystalline form. The columns indicate data measured and analyzed in different ways. The first column (FIGS. 1(a), 1(b), and 1(c)) contains data from a Cu K_{α} x-ray source. The second column (FIGS. 1(d), 1(e), and 1(f)) contains the pair distribution functions (PDFs) obtained by Fourier transforming the conventional data shown in the first column. The third column (FIGS. 1(g), 1(h), and 1(i)) shows the synchrotron total scattering data in the form of F(Q). The fourth column (FIGS. 1(j), 1(k), and 1(l)) contains the total scattering data in the form of the total scattering PDF, G(r), obtained by Fourier transforming the data in the third column. The non-crystalline sample can be identified as being “amorphous” from the conventional XRPD data in the first two columns; however, the nature of the local packing cannot be ascertained. In contrast, in the third and fourth columns, it is immediately apparent that the non-crystalline sample resembles the n-form and not the y-form.

FIG. 2 shows a comparison of the total scattering atomic pair distribution function (TSPDF) from the non-crystalline sample (light grey) and the beta crystalline sample that was modified as if it were a 4.5 nm nanoparticle (dark grey). The difference between the two plots is also shown.

FIG. 3 shows diffraction patterns and PDFs of indomethacin (IND). The top row of panels, (FIGS. 3(a), 3(d), and 3(g)) contain patterns from IND in the α crystalline form, the middle row (FIGS. 3(b), 3(e), and 3(h)) in the non-crystalline form and the bottom row (FIGS. 3(c), 3(f), and 3(i)) in the gamma crystalline form. The columns indicate data measured and analyzed in different ways. The first column (FIGS. 3(a), 3(b), and 3(c)) contains data from the in-house Cu Kα x-ray source. The second column, (FIGS. 3(d), 3(e), and 3(f)), contains the synchrotron total scattering data in the form of F(Q). The third column, (FIG. 3(g), 3(h), and (i)), contains the total scattering data in the form of the total scattering PDF, G(r), obtained by Fourier transforming the data in the third column. The non-crystalline sample can be identified as being “amorphous” from the conventional XRPD data in the first column but the total scattering data is rich in information. Unlike the CBZ, in this case the non-crystalline IND has a structure that is distinct from either of the two crystalline analogs.

FIG. 4 is a schematic showing a system for characterizing a solid small molecule organic material.

FIG. 5 shows data collected from aspirin in the form of PDF being smeared.

FIG. 6 shows data collected from aspirin in the form of PDF being stretched.

### DETAILED DESCRIPTION OF EXEMPLARY EMBODIMENTS

In accordance with the described subject matter, systems and methods are provided to fully characterize the internal structure of a chemical sample. The chemical sample can be essentially any chemical compound or product. For example but not limitation, the organic sample can be organic or inorganic. The chemical sample can be a drug, therapeutic agent, contrast agent, imaging agent, a product such as a drug product, or a mixture of components. For example, the chemical sample can be a particulate drug or a micronized drug. Some non-limiting examples of drugs include aripiprazole, salmeterol, salbutamol, fluticasone, beclomethasone, paclitaxel or docetaxel. Further, the chemical sample may be a liquid, gel, suspension, polymer matrix, or solid. The chemical sample can be a solid small molecule organic material, crystalline, non-crystalline, amorphous, nanocrystalline, or distorted chemical compound. The sample may also include multiple structural phases, each of which may be crystalline, non-crystalline, amorphous, nanocrystalline, or distorted.

The chemical sample may be an organic material containing one or more carbon atom(s) and at least one other element, such as hydrogen, nitrogen, and/or oxygen. For example, the carbamazepine molecule contains carbon, hydrogen, nitrogen, and oxygen, and the indomethacin molecule contains chlorine in addition to carbon, hydrogen, nitrogen, and oxygen. In yet another preferred embodiment, the chemical sample can be a small molecule organic material containing carbon, hydrogen, and at least one additional element. In an additional preferred embodiment, the small molecule organic material contains carbon, hydrogen, and nitrogen; or carbon, hydrogen, and oxygen.

The approaches described yield unprecedented quality information that is useful for industrial and research settings in the study of drug development and commercialization of, for example, amorphous and nanocrystalline organic materials, as well as for the regulatory agencies that approve amorphous and nanocrystalline drugs. In this regard, the methods described are useful to assess or identify the stability, positional variations, and structural phases of the chemical sample. For example, the methods can fully characterize the internal structure of the sample, and identify one or more structural phases that may exist within the sample such as crystalline, amorphous and nanocrystalline forms of the sample. The method can determine quantitative structural and molecular packing information of the sample.

When the method is used to assess the stability of a chemical sample, such as an organic drug, information can be gained about the shelf-life stability, phase stability, and/or process history stability of the sample. In this embodiment, the chemical sample is subjected to x-ray total scattering to define a first dataset. The sample can then be stored for an amount of time or processed under one or more conditions to define a potentially modified sample. The time may be predetermined, and may be, for example, three months or twenty-four months. The conditions may include temperature, pressure, humidity, illumination, or atmospheric composition.

The potentially modified chemical sample is subjected to x-ray total scattering to define a second dataset. The datasets can be analyzed to assess the stability or change in the internal structure of the chemical sample over time or under the conditions. In one embodiment, the first and second datasets comprise atomic pair distribution functions, reduced structure functions, or other functions that are mathematically related to these functions. The method is useful for determining changes in the organic material over time or over certain conditions. In particular, stability assessments required by regulatory agencies for marketing approval can be conducted using the methods described herein. This is especially useful when seeking regulatory approval of drug products comprising a drug at the nanoscale, as such changes in drug or product stability can go undetected by conventional techniques such as X-Ray Powder Diffraction (“XRPD”).

High-energy x-ray total scattering coupled with mathematical transformation of the generated data, such as making corrections to obtain the total scattering reduced structure function, F(Q), and pair distribution function (PDF) analysis, produces unique structural fingerprints from amorphous and certain nanostructured phases of active pharmaceuticals. This new way of characterizing such materials opens the door to the quantitative study and application of drugs in these forms.

As used herein, “X-ray total scattering analysis” means using high energy x-ray powder diffraction to provide structure-relevant scattering data over a wide range of reciprocal space, including both Bragg scattering and diffuse scattering. Bragg scattering means the set of sharp, discrete diffraction peaks exhibited by an ordered crystalline structure when bombarded with energy sources such as x-rays. When the structure is not completely ordered, then Bragg scattering intensities are diminished, and diffuse scattering intensities, which are the scattered intensities located outside Bragg scattering intensities, appear.

As used herein, “wide range of reciprocal space” means reciprocal lattice vector, Q, ranging from at most 1 inverse angstrom to at least about 5.0 inverse angstroms. For example but not limitation, the maximum Q value may be above about 5.0, 10, 12, 14, 16, 18, 20, 22, 24, 26, 28, or 30 inverse angstroms. For example, the minimum Q value may be as low as about 0 inverse angstroms. Preferably, Q is from about 1 inverse angstrom to about 30 inverse angstroms, including from about 1 inverse angstrom to about 28 inverse angstroms, including from about 1 inverse angstrom to about 26 inverse angstroms, including from about 1 inverse angstrom to about 24 inverse angstroms, including from about 1 inverse angstrom to about 22 inverse angstroms, including from about 1 inverse angstrom to about 20 inverse angstroms, about 1 inverse angstrom to about 18 inverse angstroms, and from about 1 inverse angstrom to about 16 inverse angstroms, including from about 1 inverse angstrom to about 14 inverse angstroms, including from about 1 inverse angstrom to about 12 inverse angstroms, and including from about 1 inverse angstrom to about 10 inverse angstroms. Q values are determined using the following equation:

$$Q = \frac{4 π sin ( θ )}{λ} ,$$

wherein θ is the Bragg angle, and λ is the wavelength of the x-ray beam. As used herein, a “Bragg angle” means half scattering angle, which is the angle between the beam axis and the scattered intensity.

“High energy x-ray powder diffraction” means x-ray powder diffraction carried out using high frequency x-ray beams, the wavelength of which is less than or equal to 2.0 angstroms. For example, high energy x-ray powder diffraction may be carried out using x-ray beams, the wavelength of which is less than or equal to 0.8 angstroms. Preferably, the x-ray source is synchrotron radiation. The key, however, is not the use of synchrotron radiation per se but collecting data over a wide range of Q with good statistics. It is understood by those skilled in the art that such data is obtainable from many different x-ray beam sources other than synchrotron radiation, such as laboratory based diffractometers that have silver or molybdenum sources (13). Instruments with a molybdenum source are commercially available from such manufacturers as Siemens Corporation (New York, N.Y.), Rigaku (Tokyo, Japan), and Panalytical B.V. (Almelo, the Netherlands). The data presented in the Examples below were Fourier transformed with a Qₘₐₓ of 18 Å⁻¹, which is accessible with a silver source lab diffractometer. Such instruments are currently under development by Panalytical B.V. (Almelo, the Netherlands) and Siemens Corporation (New York, N.Y.). The synchrotron measurements are preferable because the requisite statistics can be obtained over the whole Q-range in a short time (30 minutes or less) compared to many hours on a lab-based source. Future developments in high intensity laboratory sources with silver anodes could help this situation considerably.

The term “solid” means states of matter characterized by resistance to deformation and changes of volume.

A “small molecule organic material” means any non-polymeric chemical compound, or a salt, a solvate, or a hydrate thereof, which contains one or more carbon atom(s) and the individual molecules of which are no more than 5 nm in length.

As used herein, the term “drug” means (A) articles recognized in the official United States Pharmacopoeia, official Homoeopathic Pharmacopoeia of the United States, or official National Formulary, or any supplement to any of them; and (B) articles intended for use in the diagnosis, cure, mitigation, treatment, or prevention of disease in man or other animals; and (C) articles (other than food) intended to affect the structure or any function of the body of man or other animals; and (D) articles intended for use as a component of any article specified in clause (A), (B), or (C).

The term “drug product” means any article that contains any drug. Drug product includes pure chemical entity or any composition, mixture or formulation containing the drug. The drug product can be a liquid, gel, suspension, solution, polymer matrix, or powder form.

In one embodiment, a method is described for determining the internal structure of an organic sample. The solid small molecule organic material may be subjected to x-ray total scattering analysis can be in the form of a powder, such as a fine powder, or any other form that scatters isotropically, or almost isotropically, such as an amorphous or nanocrystalline solid, a solution, a liquid, a gel, or a suspension. Such sample may be prepared in any methods that are suitable for samples used in conventional x-ray powder diffraction. The samples may be placed in a capillary, on a plate, or on or in any other platforms or containers or other means as directed by the manufacturer of the x-ray powder diffraction instrument.

In one aspect of this embodiment, the method further comprises collecting data generated by x-ray total scattering analysis of an organic material, and mathematically transforming the generated data to provide a refined data set.

Collecting data generated by x-ray total scattering analysis of an organic material includes, but is not limited to gathering, displaying, and/or recording relevant structural x-ray data, e.g., over a range of Bragg angles. For example, data that may be generated and collected include an associated intensity of the diffraction at a specific Bragg angle, wavelength of the x-ray beam, position of the detector used to record the intensity of the diffraction and the associated intensity of the diffraction at a specific position, and/or total scattering data. The generated data may be recorded, captured, displayed, and/or saved in any convenient manners, for example, on film or by a machine such as a computer.

As used herein, “mathematically transforming” the generated data to provide a refined data set means manipulating data mathematically such that the pre-transformed data, e.g., generated data, is related to the post-transformed data, e.g., the refined data set, by a specific function. For example, pre-transformed data may be divided, subtracted from, or otherwise normalized by any smoothing function whose periodicity is greater than 2π/d, wherein d is the nearest neighbor distance, which is the smallest distance between two atoms in the material. Smoothing function means any function which has continuous derivative over the range and around which the pre-transformed data oscillates. An example is a portion of a Gaussian distribution that fits within the pre-transformed data. Other examples are provided below. Mathematical transformations also include Fourier transformation, which is an operation that transforms one complex-valued function of a real variable into another. Mathematical transformations are preferably performed by a machine, such as a computer, using programs, such as PDFgetX2 (16). However, it is understood by those skilled in the art that other comparable programs may be used to perform mathematical transformations. Such comparable programs include RAD, FIT, PEDX, and IFO (17-19).

In one embodiment, the generated data are mathematically transformed to a “reduced total scattering structure function” (“F(Q)”) or a mathematically related function of F(Q). As used herein, F(Q) is obtained by the following equation:

F(Q)=Q[S(Q)−1]

where S(Q), the total scattering structure function, contains the measured intensity from the small molecule organic material and is defined in the equation as follows:

$$S ( Q ) = \frac{{I}_{c} ( Q ) - 〈 {f}^{2} 〉}{{〈 f 〉}^{2}} + 1$$

wherein I_{c}(Q) is the coherent powder diffraction intensity that may or may not have been corrected according to experimental conditions, and wherein f=Z is the atomic scattering factor evaluated at Q=0, where Z is the atomic number. Preferably, l_{c}(Q) is the powder diffraction intensity that has been properly corrected by removing experimental artifacts, fluorescence, multiple scattering and Compton scattering, corrected for such effects as sample self-absorption, and normalized by the incident intensity and the number of scatterers in the sample. The notation, < . . . >, indicate compositionally weighted averages over the atomic species in the sample. Another way of writing the equation deriving S(Q) is as follows:

$$S ( Q ) = \frac{{I}_{c} ( Q ) - \sum {c}_{i} {\vert {f}_{i} ( Q ) \vert}^{2}}{{\vert \sum c {f}_{i} ( Q ) \vert}^{2}} + 1 ,$$

Wherein cᵢ and fᵢ are the atomic concentration and x-ray atomic form factor, respectively, for the atomic species of type i, and Σcᵢ=1.

In another embodiment, the generated data are mathematically transformed to an experimentally derived atomic pair distribution function (PDF) or a mathematically related function. “Experimentally derived atomic pair distribution function (PDF)” is related to the measured total scattering data through a sine Fourier transform. The general sine Fourier transform function is as follows:

G′(r)=2c∫ₓ^{y}F(Q)sin(Qr)dQ

where r is a radial distance, and c is any constant, and x is greater than or equal to 0; and y is any number between x and infinity.

It is understood by those skilled in the art that the equations set forth above may be re-written in a different way depending on the experimental conditions, such as corrections for background and/or anomalous-scattering. For example, the PDF may be linked the scattering through the sine Fourier transform:

G′(r)=(2/π)∫_{Qmin}^{∞}F(Q)sin(Qr)dQ

wherein Qₘᵢₙ is a Q value that excludes any small angle scattering intensity but includes all the wide-angle scattering (10).

Once obtained, the reduced scattering function, atomic pair distribution function, or other mathematically related function, may be used to determine the internal structure of the organic sample being analyzed. This determination of the internal structure may include modeling of the structure of the organic sample according to methods known to those of ordinary experience in the art. The techniques described in the present disclosure are useful to determine the internal structure of the samples under analysis even where conventional XPRD techniques fail.

As used herein a “mathematically related function” is any function related to F(Q) or PDF through a reversible mathematical transformation.

The material being analyzed may also include multiple structural phases that can be distinguished by the techniques described in the present disclosure. The reduced scattering function, atomic pair distribution function, or other related mathematical function, may be used to determine the relative abundance of these phases. The structural phases may each be crystalline, non-crystalline, amorphous, nanocrystalline, or distorted. The methods of the present disclosure may be used to distinguish internal structural phases even where conventional XPRD techniques fail.

Another useful aspect of this embodiment is that it can detect variations in structural composition both within and between dosage forms.

In another aspect of this embodiment, the solid small molecule organic material is a crystalline material. In a further aspect of this embodiment, the solid small molecule organic material is a non-crystalline material. Preferably, the non-crystalline material is a nanocrystalline material or an amorphous material. In an additional aspect of this embodiment, the solid small molecule organic material is a distorted crystal.

Similarly, the methods described above may be used to identify components of a mixture. According to this embodiment, an x-ray total scattering analysis dataset is collected from the mixture, and the resulting dataset is converted to a PDF, RSF, or related mathematical function as described above. Analysis of the dataset may then allow identification of one of the components e mixture, including identification of any amorphous or nanocrystalline constitutents in the mixture. The mixture may be a solid mixture or a gell, a liquid, or a suspension. The mixture under analysis may also be a pharmaceutical formulation, which may include one or more drugs. The drugs may be dispersed in a polymer matrix.

The methods described herein may also be used to determine the proportion of crystalline, amorphous, or nanocrystalline constituents in the material. According to this embodiment, and x-ray total scattering analysis dataset is collected from the material, and the resulting dataset is converted to a PDF, RSF, or related mathematical function as described above. Analysis of the dataset then allows determination of the proportions of crystalline, amorphous, or nanocrystalling constituents in the material. The material may contain more than one distinct phase of each type, for example, it may contain two distinct crystalline phases. The presently described method is capable of distinguishing between, for example, the two distinct crystalline phases in the material.

As used herein, a “crystalline material” means any material that has long range order. Its structure may be defined by a small number of parameters that define the unit cell (its shape and size) and its contents (atomic coordinates and thermal factors). The complete structure is then obtained by periodically repeating this unit cell over the long range, which means a domain size of greater than about 10-100 nm. The required domain size for a material to be considered crystalline depends on the sizes of the individual molecules composing the material and the number of molecules within the domain.

The nanoscale structure of crystalline materials may sometimes be distorted. A “distorted crystal” means a material with long-range order, but which suffers significant structural distortions that are not reflected in the average structure. An example of such a distortion would be atomic displacements that are correlated only over nanometer length scales

A “non-crystalline material” is any material that is not a crystalline material nor a distorted crystal. A non-crystalline material includes but is not limited to amorphous material and nanocrystalline material.

An “amorphous material” means a material that does not have well defined structure or has well-defined structure at length scales less than about 2 nanometers.

A “nanocrystalline material” means a material that has well-defined structure over local and intermediate ranges of about 1-1000 nanometers. For example, a nanocrystalline material may have well-defined structure over the range of about 1-800 nanometers, including about 1-700 nanometers, 1-600 nanometers, 1-500 nanometers, 1-400 nanometers, 1-300 nanometers, 1-200 nanometers, 1-150 nanometers, and about 1-100 nanometers. It can often be described by a small unit cell and a small number of parameters, but the order extends only on a nanometer length-scale. Note that this definition of nanocrystals goes beyond perfect crystals that are simply very small (nanometer in size) and includes material where the particle size can be larger but the structural coherence is at the nanometer length-scale. Certain nanocrystalline material appears as “amorphous” “x-ray amorphous” if analyzed using conventional XRPD. Some examples of such nanocrystalline materials are set forth in Examples 1-4 below.

Another embodiment is a method of distinguishing between amorphous and nanocrystalline materials. Conventional XRPD techniques fail to detect whether a particular form of an organic small molecule material is nanocrystalline or amorphous. The techniques described in the present disclosure can detect whether the sample under analysis is amorphous or nanocrystalline, including when the organic sample has long range order on scales of less than 100 nm. This is advantageous in characterizing samples, as the properties of amorphous solids may be significantly different from the properties of nanocrystalline solids. This embodiment is particularly useful in characterizing samples of aripiprazole, salmeterol, salbutamol, fluticasone, beclomethasone, paclitaxel, or docetaxel.

Another embodiment is a product. The product comprises a data set of x-ray total scattering analysis of a solid small molecule organic material. The solid small molecule organic material is as disclosed above.

Yet another embodiment of the present invention is a method of comparing solid small molecule organic materials. This method comprises (a) subjecting a first solid small molecule organic material to x-ray total scattering analysis and collecting a first set of data generated thereby; (b) subjecting a second solid small molecule organic material to x-ray total scattering analysis and collecting a second set of data generated thereby; (c) optionally, mathematically transforming the first set of generated data to provide a first refined set of data and mathematically transforming the second set of generated data to provide a second refined set of data; and (d) comparing the first set of generated data and the second set of generated data or the first set of refined data and the second set of refined data to determine a difference or a similarity therein, wherein a similarity represents that the first and the second solid small molecule organic material have similar structures, and a difference represents that the first and the second solid small molecule organic material have different structures.

In one aspect of this embodiment, the method comprises mathematically transforming the first set of generated data to provide a first refined set of data and mathematically transforming the second set of generated data to provide a second refined set of data.

In one preferred embodiment, the first set of generated data and the second set of generated data are mathematically transformed to a reduced total scattering structure function. In another preferred embodiment, the first set of generated data and the second set of generated data are mathematically transformed to an experimentally derived atomic pair distribution function (PDF). Reduced total scattering structure function and experimentally derived atomic pair distribution function are as disclosed above.

Comparing two or more sets of data or graphical representation of the data may be performed in any convenient way. Comparisons may be performed manually. Preferably, comparisons are performed using a machine, such as a computer. Data may be presented in reciprocal space or in real space. All sets of data may be presented in a graphical manner, with the independent variable on the x-axis and the dependent variable on the y-axis. For example, data may be presented as a plot of intensity vs. 2θ, intensity vs. θ, intensity vs. Q, intensity vs. d-spacing, F(Q) vs. Q, and G(r) vs. r. Preferably, data are presented as a plot of F(Q) vs. Q, or G(r) vs. r. The variables, θ, Q, F(Q), r, and G(r) are as defined above.

Data may be compared using qualitative methods. For example, two or more sets of data may be superimposed on each other for the ease of comparing the position and height of features (such as peaks and valleys) in the plot.

Data may also be compared quantitatively. Many statistical tests suitable for comparing two sets or more sets of data are available. For example, a “goodness of agreement” parameter between the two sets of data may be specified. Such a parameter may be accomplished by evaluating the sum of the squares of the differences between the two datasets over a range of the data points defined as {square root over (Σ(Pᵢ(1)−Pᵢ(2))²)}, where Pᵢ(1) is the value of the i^{th} point in the first set of data, and Pᵢ(2) is the value of the i^{th} pointing in the second set of data. In other words, one set of data is designated as the reference. At each point of the independent variable, the dependent variable of the reference is subtracted from the corresponding dependent variable of the other set of data. The result of the subtraction is squared and summed. The result of the subtraction may alternatively be presented in a graphical manner, with the independent variable on the x-axis and the dependent variable being the result of the subtraction. It is understood by those skilled in the art that there are a number of similar expressions that may be used to accomplish the same purpose. For example, each point in the sum could be weighted by a measure of its statistical significance, or the evaluation could be carried out after any low-frequency backgrounds have been removed from the data by fitting and subtraction.

Another example of a quantitative method is based on an evaluation of a number of strongest peaks. Here, “peak” refers to the high points in a graph when the data is presented in a graphical format, or the corresponding points of data when not presented in a graphical format. “Strongest peaks” refers to those peaks with the biggest amplitudes. In this method, the position and the amplitude of the strongest 1-30 peaks in the first set of generated data or in the first set of refined data are determined. Preferably, the strongest 5-15, and more preferably, the strongest 10 peaks are determined. These peaks are compared to the corresponding number of strongest peaks in the second set of generated data or refined data. Optionally, the amplitude of the intensities or peaks in both sets of data are normalized, for instance, by scaling to the amplitude of the strongest peak.

The judgment whether the two sets of data are similar or different depends on the evaluation of the position and the amplitude of the peaks. The judgment may be made solely on the basis of the position of the peaks. For example, the two sets of data may be judged to be the same if the positions of the peaks or the intensities differ no more than 30% of total range of data examined, including not more than 20%, 10%, 5%, 1%, 0.5%, 0.1%, 0.05%, or 0.01% of the total range of the data examined. The judgment may also be made solely on the basis of the amplitudes of the peaks. For example, the two sets of data may be judged to be the same if the amplitudes of the peaks from the second set of data are within 30%, preferably within 20%, or within 10% of the amplitude of the corresponding peaks from the first set of data. Preferably, the judgment whether the two sets of data are similar or different depends both the positions and the amplitudes of the peaks.

Other statistical methods, such as correlation measurements, may also be used to analyze the differences and similarities between two or more sets of data. Correlation analysis includes, for example, Pearson correlation, Kendall rank correlation and Spearman correlation. Generally, correlation analysis gives a correlation value R in the range of −1 to 1 between each pair of data-set. A value of 1 implies complete correlation, zero means uncorrelated, and a value of −1 implies complete inverse correlation. If two sets of data are highly correlated, then they are highly similar. If two sets of data are uncorrelated, then they are highly dissimilar. Correlation techniques are extremely powerful because they ignore absolute scaling, but are sensitive to relative scaling and slight shifts in peak positions.

Additionally, commercial computer software programs are available to analyze the differences and similarities between two or more sets of data. For example, PolySNAP2 and PolySNAP M (University of Glasgow, Glasgow, United Kingdom) rank patterns in order of their similarity to any selected sample (25). These software programs give a number between 0 and 1 to describe the similarity or differences, with 0 signifying that two sets of data are very different, and 1 signifying that the two sets of data are the same. IBM SPSS Statistics software (SPSS Inc., Chicago, Ill.) may also be used to provide correlation coefficients using Pearson correlation, Kendall rank correlation and/or Spearman correlation methods.

Comparison may be performed over a range of points, such as the entire data set, or 10%, 20%, 30%, 40%, 50%, 60%, 70%, 80%, 90%, 91%, 92%, 93%, 94%, 95%, 96%, 97%, 98%, or 99% of the data set. It may also be performed over data corresponding to the range dominated by inter-molecular interactions, such as above 3 angstroms, including 3-30 Angstroms, 3-20 angstroms, or 3-6 angstroms. Larger ranges, for example, from 0.1-30 angstroms, may also be used. Preferably, the data used for comparison is the entire set above 3 Angstroms. The range may be continuous or discontinuous.

In an additional aspect of this embodiment, mathematical transformation of at least one set of generated data comprises scaling, stretching, smearing, or a combination thereof. The scaled, stretch, or smeared data may then be compared to the other set of transformed data.

“Scaling” means to multiply the data by a multiplier, or a scale factor. The scale factor may be a constant. Scaling may be performed manually or automatically using a computer program. For example, when manually scaling the one set of data, the data points are multiplied by a given scale factor.

Automatically scaling one set of data to the other set may be done in many ways. One way is to determine the scale factor via linear or non-linear regression with zero offset. In this procedure, the scale factor is determined according to the standard linear regression formula: the covariance of the first and second data sets divided by the variance of the first data set.

Another example of a scaling method uses physical considerations to scale the first data set, which is preferably transformed to PDF first. In this procedure, the PDF is converted to the radial distribution function (RDF) by subtracting a linear baseline from the PDF and multiplying this by r, the radial distance. This baseline is either provided manually or estimate by fitting the bottom of the low-r signal with a linear function via least-squares regression. The estimated baseline may be pre-set to prefer the bottom of the low-r signal by adding a penalty function to the least-squares cost function where the estimated baseline is greater than the low-r signal. The RDF is obtained from the PDF by subtracting this baseline and multiplying the result by r. This operation may be performed for both sets of data. The RDF represents the weighted average number of atom-pairs within a given interaction distance, and its integral is the weighted total number of atom pairs within a given interaction distance. To scale the first set of data in the form of RDF, it is divided by its integral and multiplied by the integral of the other RDF. This procedure therefore scales the first set of data in the form of RDF to represent the same number of atom pairs as the second set of data in the form of RDF. Once the first set of data in the form of RDF is scaled, the baseline is also scaled. Subsequently, the data in the form of RDF is converted back into the PDF. This method requires a good baseline estimate for both sets of data. Thus, to use this method, data are usually collected from macroscopic samples, because nano-scale samples may not have a linear baseline.

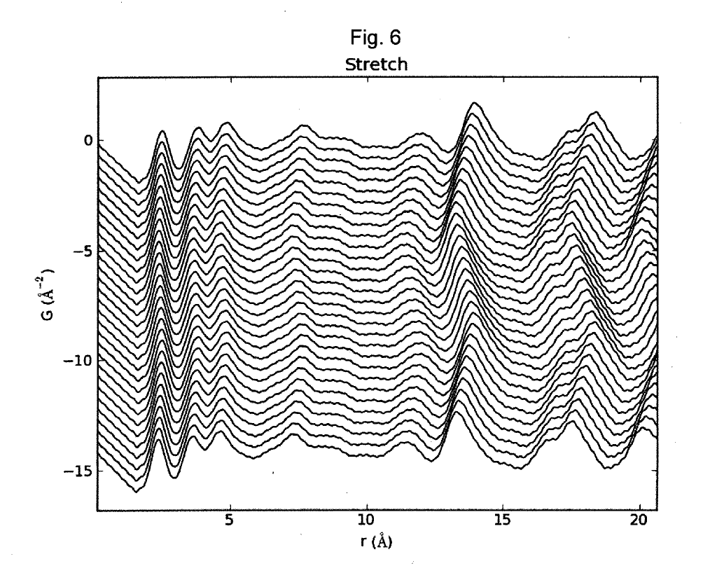

“Stretching” means extending or compressing the data, preferably in the form of PDF, on the r-scale, like a concertina, to mimic changes in lattice parameter. FIG. 6 shows a PDF of aspirin being stretched. Stretching may be used to simulate a difference in temperature at which the samples were subjected to x-ray total scattering analysis, for example. Stretching one set of data in the form of PDF onto the other may be performed by rescaling the r-axis of the first set of data. Given a stretch factor, the r-values are multiplied by (1+stretch factor) to expand or contract the r-scale by the desired amount. The stretched data are then linearly interpolated (rebinned) back onto its original grid from the stretched grid for easier comparison with the other set of data in the form of PDF. The stretch factor may be determined manually, by trial and error, for example. When automating this operation, the scale factor is determined via least-squares regression, where the absolute difference between the two sets of data is minimized. This operation may be performed on the data in the PDF form or on the data using an estimated RDF, as described above.

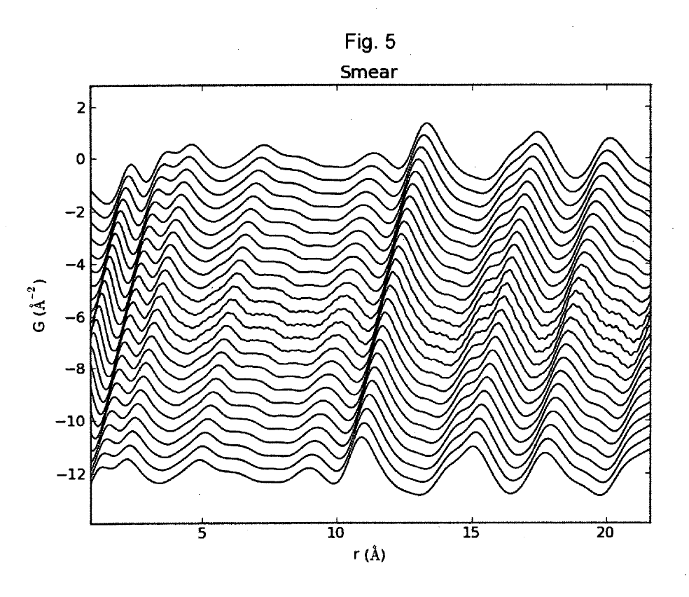

“Smearing” means broadening of certain features in one set of data, preferably in the form of PDF, to simulate peak broadening in the second set of data, preferably also in the form of PDF. Such broadening may be used to simulate a difference in temperature at which the samples were subjected to x-ray total scattering analysis, for example. FIG. 5 shows a PDF of aspirin being smeared. Preferably, smearing is performed on data in the form of an estimated RDF rather than the PDF, because the RDF peaks are Gaussian whereas the PDF peaks are not (though the errors are quite small if data in the form of PDF is smeared directly). Preferably, to perform the smear operation, the PDF is converted to the RDF as described above, and then the data are convoluted with a Gaussian with a chosen broadening factor as the width. The numerical convolution is performed such that the centroid and integrated amplitude of the smeared data does not change. Smearing may be performed automatically, for example, via least-squares regression as described above.

In sum, scaling, stretching and smearing may be automated using a regression algorithm (e.g., least squares) so that the optimal values for the scale, stretch and smear factors are found such that they morph one set of data, preferably in the form of PDF or RDF, as close as possible to the second set of data, also preferably in PDF or RDF. Note that these operations may be combined. For example, during each regression loop, one set of data may be scaled, stretched and smeared in that order (or in another order) as described above, according to parameters provided by the optimization algorithm. Preferably, the conversion from PDF to RDF is performed once, before regression, and the conversion from RDF to PDF is performed as described above after the optimal morphing parameters are found.

In another aspect of this embodiment, the first solid small molecule organic material and the second solid small molecule organic material have the same molecular structure, but have been subjected to different processing protocol. As used herein, different processing protocol means being treated under different conditions, such as temperature, pressure, and/or chemical environment. For example, the second small molecule organic material may be a recrystallized form of the first small molecule organic material. Recrystallization process may include a different temperature annealing regimen or a different solvent system, for example. In one embodiment, different processing protocols include different storage times and/or storage conditions. More preferably, the method further comprises correlating the differences in the first set of generated data and the second set of generated data or the differences in the first set of refined data and the second set of refined data, the storage time, or the storage condition to the stability of the solid small molecule organic material.

As used herein, “molecular structure” means three-dimensional arrangement of the atoms that constitute a molecule, but does not include the three-dimensional arrangement of the molecules into a larger structure. “Storage time” means duration from the time the solid small molecule organic material is made to the time the x-ray total scattering data from the small molecule organic material is collected. “Storage condition” means the condition under which the solid small molecule organic material is stored after it was made. Storage condition includes but is not limited to temperature, pressure, pH, humidity, and light, chemical composition of the atmosphere or combinations thereof. As used herein, “chemical composition of the atmosphere” means the gaseous substance(s) (if any) with which the small molecule organic material is in contact. Some non-limiting exemplary chemical composition of the atmosphere include vacuum, pure nitrogen, and composition of air at sea level.

As used herein, “correlating” means relating. The relationship may or may not be linear. Such correlation yields different information regarding a solid small molecule organic material, including stability information and consistency of manufacturing process.

For example, to assess the stability of a solid small molecule organic material over a certain period of time, a sample of the material may be subjected to x-ray total scattering analysis. After a certain period of time, the same sample, or a second sample of the same material that has been stored under the same conditions for a different length of time, may be subjected to x-ray total scattering analysis. If it is determined that the two sets of generated data or refined data are the same, then the sample is stable for that period of time. Conversely, if it is determined that the two sets of generated data or refined data are different, then the sample is degrading over that period of time and under those conditions. Methods of comparing the two sets of data are as set forth above.

In another example, the effects of different storage conditions on the solid small molecule organic material may be assessed. Two different samples of the material may be stored under different temperatures, one at 20° C., and the other at 4° C. After a certain period of time, both samples may be subjected to x-ray total scattering analysis. If it is known that the material is stable at 4° C. over that period of time, and if it is determined that the two sets of generated data or refined data are the same, then the differences in temperature do not have an effect on the stability of the material. The material may also be stored at 20° C. over that period of time. Conversely, if it is determined that the two sets of generated data or refined data are different, then the differences in temperature have an effect. This example may be applied mutatis mutandis to other storage conditions such as light, humidity, pressure, pH, or combinations thereof.

In yet another example, x-ray total scattering analysis may also be used to verify the consistency of a manufacturing process for such a material. A sample may be taken from two different lots of a solid small molecule organic material, which were manufactured using the same synthetic process. Both samples may be subjected to x-ray total scattering analysis. If it is determined that the two sets of generated data or refined data are the same, then there is consistency in making the material. Conversely, if it is determined that the two sets of generated data or refined data are different, then the manufacturing process is inconsistent. This example may be applied mutatis mutandis to changes in manufacturing process, including without limitation, scaling up the production of a solid small molecule organic material, use of different solvents or machineries in the production process, differences between manufacturing locations, and changes in starting materials and synthetic scheme.

Another exemplary embodiment is a method of characterizing a nanocrystalline organic material. This method comprises subjecting a sample including the nanocrystalline organic material to x-ray total scattering analysis and collecting a set of data generated thereby; (b) applying a mathematical modulation to the set of data; and (c) using modeling to determine the structure of the nanocrystalline material.

Another exemplary embodiment is a method of characterizing a nanocrystalline organic material. This method comprises (a) subjecting a sample including the nanocrystalline organic material to x-ray total scattering analysis and collecting a first set of data generated thereby; (b) subjecting a crystalline solid small molecule organic material to x-ray total scattering analysis and collecting a second set of data generated thereby, wherein the crystalline solid small molecule organic material has the same molecular structure as the nanocrystalline solid small molecule organic material; and (c) applying a mathematical modulation to the first set of generated data, or the second set of generated data, or both the first set and the second set of generated data to determine the structure of the nanocrystalline material. If, after the appropriate mathematical modulation, the first set and the second set of generated data are sufficiently similar, then the crystal structure of the nanocrystalline material is known to be the same as the crystal structure of the crystalline solid.

In one aspect of this embodiment, the mathematical modulation comprises mathematically transforming the first set of generated data and the second set of generated data using a PDF to provide a first set of refined data and a second set of refined data; and apply a mathematical function to the second set of refined data to generate a modified second set of data such that the modified second set of data is in substantial agreement with the first set of refined data; wherein the mathematical function mimics the loss of far neighbor contribution outside a hypothetical particle, and wherein the size of the hypothetical particle is the size of the nanocrystal. PDF is as disclosed above.

In one example, the hypothetical particle is spherical. The mathematical function mimicking the loss of far neighbor contribution outside a hypothetical spherical particle is as follows (11):

$$f ( r ; d ) = [ 1 - \frac{3 r}{2 d} + \frac{1}{2} {( \frac{r}{d} )}^{3} ] Φ ( d - r ) ,$$

wherein d is the diameter of the spherical particle, and Φ(x) is a Heaviside step function that has value 1 in the region r≦d and value 0 for r>d.

Substantial agreement may be determined by a qualitative method or a quantitative method which minimizes the differences between the modified second set of data and the first set of refined data. In one example, the differences between the modified second set of data and the first set of refined data may be described by the “goodness of agreement” parameters as set forth above in the disclosure relating to methods for comparing data. In another example, differences between the modified second set of data and the first set of refined data may be minimized using existing statistical softwares, such as PolySNAP 2 and PolySNAP M.

Furthermore, this method may be used to extract quantitative data, for example, about the percentage of crystallization in a sample known to start as a nanocrystalline material and over time, crystallize into a crystalline material. The starting material and degraded material may be first subjected to x-ray total scattering analysis, and mathematically transformed to provide a refined set of data. The sample is then subjected to x-ray total scattering analysis and mathematically transformed in a manner similar to the starting material and degraded material. Methods of mathematical transformation are as set forth above. The refined data from the starting material and the degraded material may be linearly combined, or modeled as set forth above, until substantial agreement is reached between the linearly combined data and the refined data of the sample, or between the modeled data and the refined data of the sample.

Another embodiment of the present invention is an improved method of submitting to a regulatory agency data concerning the physicochemical properties of a drug or a drug product in the form of a small molecule organic material. In this method, the improvement comprises submitting x-ray total scattering information of the drug or the drug product to the regulatory agency.

The term “regulatory agency” means a body that establishes, monitors, reforms or enforces standards in a specific area of activity. Regulatory agencies include, without limitation, United States Food and Drug Administration, European Medicines Agency, or any regulatory body which regulates drugs in the world.

The term “x-ray total scattering information” means data generated from x ray total scattering analysis and any derivations thereof, including but not limited to mathematically transformed data such as PDF data, data from reduced total scattering structure function, graphical representations of such data, description of the data, and any conclusion drawn from the data.

In one aspect of this embodiment, the regulatory agency is the United States Food and Drug Administration (FDA).

In another aspect of this embodiment, the submission is made in an investigational new drug application, an application for FDA approval to market a new drug (NDA), an abbreviated new drug application (ANDA), or in relation to maintaining the identity or quality of the solid drug.

In an additional aspect of this embodiment, the submission is made in an application for approval of a drug in amorphous or nanocrystalline form. As used herein, an “approved drug” means a drug or a drug product that is approved for sale or marketing by a regulatory agency, including for example, the FDA. The amorphous or nanocrystalline form of the approved drug has the same molecular structure as the approved drug, but may differ in local arrangements and hence may be more bioavailable than the approved drug.

In a further aspect of this embodiment, the submission is made in compliance with a requirement of Code of Federal Regulations (CFR), specifically, 21 CFR 211, 21 CFR 312, or 21 CFR 314. It is understood that CFRs may change over time and that the specific sections of CFR cited herein include successor provisions.

For example, stability information gathered from x-ray total scattering analysis may be submitted to the FDA and for the purposes of complying with good manufacturing practice for finished pharmaceuticals, for example, the requirements of 21 CFR 312.23 (investigational new drug application), 21 CFR 314.50 (application for FDA approval to market a new drug), 21 CFR 211.137 (expiration dating), 211.166 (stability test), 211.170 (testing of reserved samples), and 211.194 (maintenance of laboratory records, including stability test results).

X-ray total scattering analysis may further be used in manufacturing process control and submitted to the FDA for the purposes of submitting an investigational new drug application, for example 21 CFR 312.23; for the purposes of application for FDA approval to market a new drug, for example, the requirements of 21 CFR 314.50(d)(1); and for the purposes of complying with good manufacturing practice for finished pharmaceuticals, for example, the requirements of 21 CFR 211.84, 211.110, 211.160, and 211.194.

Additionally, x-ray total scattering analysis may be submitted in compliance with the requirements of 21 CFR 314.53 for patents that claim a polymorph that is the same as the active ingredient described in the approved or pending application.

X-ray total scattering analysis may also be used by the generic manufacturer to the FDA in an ANDA, in compliance with the requirements 21 CFR 314.94. Among other information, 21 CFR 314.94 requires chemistry, manufacturing and control information, including requirements of 21 CFR 314.50(d)(1)(i).

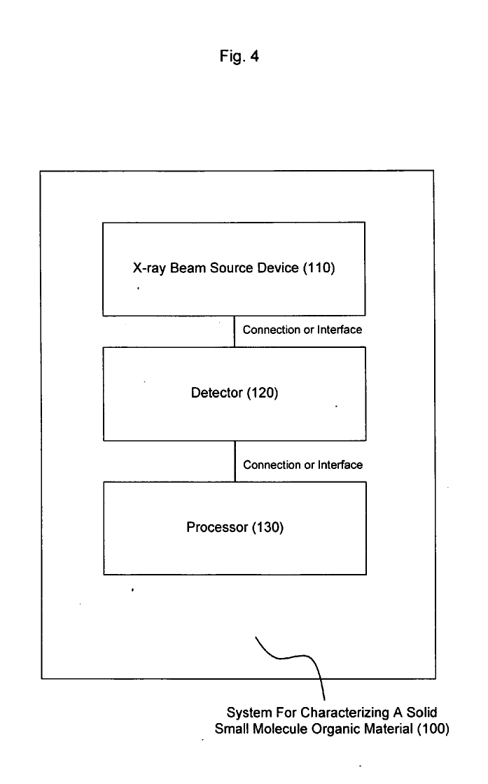

Another embodiment of the present invention is a system for characterizing a solid small molecule organic material. This system comprises (a) an x-ray beam source device adapted to subject the solid small molecule organic material to a high frequency x-ray beam; (b) a detector coupled to the x-ray beam source device and adapted to collect total scattering data that result from diffraction of the high frequency x-ray beam by the solid small molecule organic material; and (c) a processor coupled to the detector and adapted to mathematically transform data generated by subjecting the solid small molecule organic material to the high frequency x-ray beam to provide a refined data set. FIG. 4 is a schematic of this system (100), in which an x-ray beam source device (110), a detector (120), and a processor (130) are shown.

As used herein, an “x-ray beam source device” means a device which provides high frequency x-ray beams. A “high frequency x-ray beam” means an x-ray beam, the wavelength of which is less than or equal to 2.0 angstroms, such as, e.g., less than or equal to 0.8 angstroms. Suitable x-ray beam source devices according to the present invention are as disclosed herein, including without limitation, laboratory based diffractometers that have silver or molybdenum sources.

As used herein, “total scattering data” means structure-relevant scattering data over a wide range of reciprocal space, including both Bragg scattering and diffuse scattering.

As used herein, “coupled” means connected or interfaced, including over a wireless or internet-based connection. “Coupled” also includes the asynchronous transfer of data, for example by use of a flash drive or DVD. The components of the system may be connected or interfaced by one or more connection or interface devices, such as, e.g., a computer, which electronically communicates with the components of the system.

Suitable detectors according to the present invention include without limitation, 2D image plate detectors as disclosed in Chupas et al. (24).

Suitable processors according to the present invention include without limitation, computers running software applications such as, e.g., PDFgetX2, RAD, FIT, PEDX, and IFO (16-19).

Data generated by subjecting the solid small molecule organic material to the high frequency x-ray beam include, but is not limited to, an associated intensity of the diffraction at a specific Bragg angle, wavelength of the x-ray beam, position of the detector used to record the intensity of the diffraction and the associated intensity of the diffraction at a specific position, and/or total scattering data.

In one aspect of this embodiment, the generated data are mathematically transformed to a reduced total scattering structure function. Preferably, the generated data are mathematically transformed to an experimentally derived atomic pair distribution function (PDF).

In another aspect of this embodiment, the solid small molecule organic material is a drug or a drug product. The solid small molecule organic material may also be crystalline, non-crystalline, amorphous, nanocrystalline, or distorted.

In a further aspect of this embodiment, the system is in compliance with the requirements of a regulatory agency, preferably the FDA. In a preferred embodiment, the system is in compliance with the requirements of 21 CFR Part 11.

The following examples are provided to further illustrate the compositions and methods of the present invention. These examples are illustrative only and are not intended to limit the scope of the invention in any way.

In another embodiment, the present disclosure described a method of assessing positional variations in structure or composition of a sample. According to this embodiment, an x-ray total scattering analysis dataset is collected from each of two different positions within the sample, and the datasets are analyzed according to the methods described above and compared. The detected positional variations in the sample may include variations in structural composition or variations in chemical composition. The method described may detect an amorphous phase coexisting with a crystalline phase, even when the amorphous phase exists in a trace amount in the crystalline phase.

According to one aspect of the present embodiment, the two datasets may be collected by focusing the x-ray beam source on one particular position in the sample and collecting a dataset, then focusing the x-ray beam source on a different position in the dataset and collecting a sample. According to this aspect, the x-ray beam may be focused with a focal spot size of as small as one nanometer, or as large as one hundred nanometers, or potentially even larger depending on sample volume to be characterized.

According to an alternative aspect of the present embodiment, the original sample may itself by physically sampled. According to this aspect, each of the first and second samples is then independently subjected to x-ray total scattering analysis, and the resulting datasets are compared as described above.

### EXAMPLES

### Example 1

### Methods

Data were collected from samples of carbamezapine (CBZ) and indomethacin (IND) prepared by a melt-quenching method whereby molten compound was rapidly cooled in liquid N₂, lightly ground, sieved and filled into a 1 mm diameter Kapton® (Dupont, Circleville, Ohio) capillary. The laboratory data collected from a Cu Kα₁ source were collected on a Bruker-AXS D8 diffractometer using capillary transmission geometry, primary monochromated Cu Kα₁ radiation (λ=1.54056 Å) in the range 2-40 °2θ, 0.016 °2θ step size, 10 seconds per step at 100 K.

Crystalline materials were gently ground to make a fine powder. The form of the crystalline material was confirmed by conventional x-ray powder diffraction. Total scattering data were collected at beamline 11ID-B at the Advanced Photon Source (APS) in Chicago using the rapid acquisition PDF method (14). Samples were sealed in 1 mm diameter kapton tubes and irradiated with x-rays of wavelength λ=0.1370 Å. A large area 2D image plate detector (MAR345) was placed centered on and perpendicular to the incident beam 198 mm behind the sample. The short wavelength is necessary to obtain data over a high Q-range in this experimental geometry, which, in turn, is necessary to get good resolution in real-space. Q is the magnitude of the scattering vector. Q=4π sin θ/λ, where θ is the Bragg angle. To obtain sufficient statistics in the high-Q range, multiple exposures of the image plate were made, exposing for 300 seconds, between 5 and 8 times for each data-point. The separate exposures were summed together before further processing, resulting in an integrated exposure time of 30 minutes per sample.

Under these conditions, data were obtained that could be reliably used up to a Qₘₐₓ=20 Å⁻¹. 1D powder diffraction patterns were obtained by integrating around the Scherrer rings in the images from the image plate, correcting for beam polarization effects using the program Fit2D (15). Further processing to obtain the total scattering reduced structure function, F(Q), and the PDF, G(r), was done using the program PDFgetX2 (16).

### Example 2

### Total Scattering and PDF Analysis of Carbamezapine (CBZ)

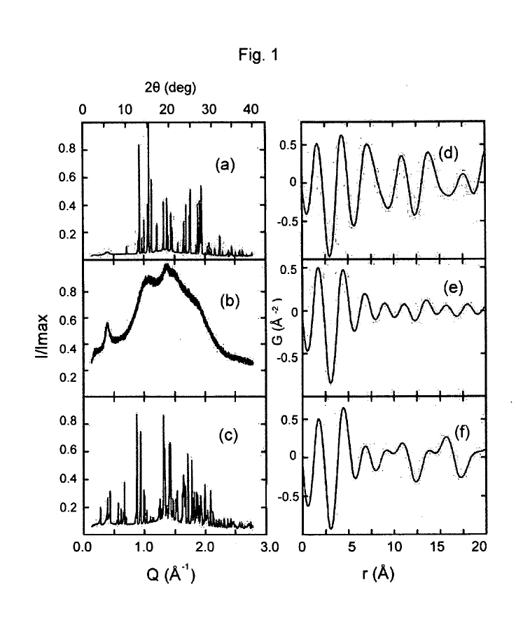

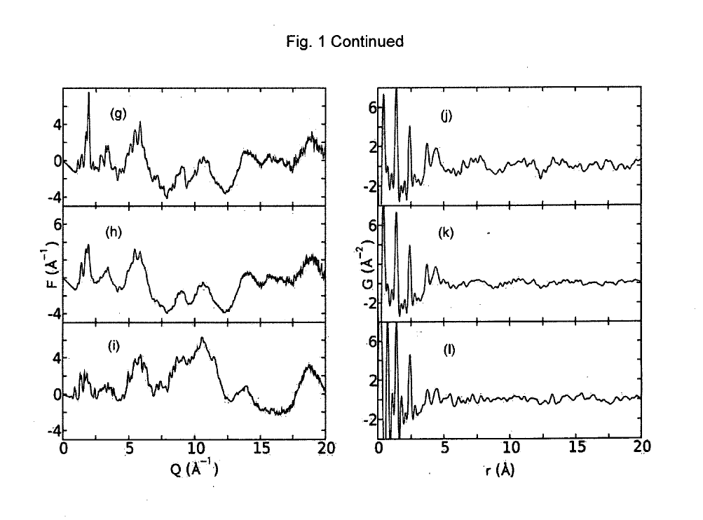

FIG. 1 summarizes the data collected from CBZ. In FIG. 1, the first row (or FIGS. 1(a), 1(d), 1(g), and 1(j)) are data collected from crystalline CBZ in the beta form, the middle row (or FIGS. 1(b), 1(e), 1(h), and 1(k)) are data collected from non-crystalline CBZ, and the bottom row (or FIGS. 1(c), 1(f), 1(i), and 1(l)) are data collected from CBZ in gamma-form. The columns have data that were measured or represented in different ways. The first column shows data from the in-house x-ray powder diffractometer collected with copper (Cu) K_{α} x-ray radiation. The second column shows the PDF obtained by Fourier transforming the data in the first column. The third column is the total scattering data from the x-ray synchrotron source, plotted in the form of the reduced total scattering structure function, F(Q). The last column shows the PDF of each sample obtained by Fourier transforming the data in the third column according to the following equations:

$$G ( r ) = ( π / 2 ) {\int }_{Q min}^{o} F ( Q ) sin Q r d Q$$

$$and$$

$$F ( Q ) = Q [ \frac{Ic ( Q ) + {〈 f 〉}^{2} - 〈 {f}^{2} 〉}{{〈 f 〉}^{2}} - 1 ] .$$

wherein Qₘᵢₙ is a Q value that excludes any small angle scattering intensity but includes all the wide-angle scattering (10).

The main result of the current work is self-evident in FIG. 1. Whereas the conventional XRPD measurement is not sufficient for differentiating the internal structure of the non-crystalline sample, the total scattering measurement and the resulting total scattering PDF clearly show that the non-crystalline CBZ has local packing of the beta type.

Column 1 (or FIGS. 1(a)-1(c)) shows data collected using conventional XRPD. It is evident that conventional XRPD is useful for unambiguously differentiating between the beta (FIG. 1(a)) and gamma (FIG. 1(c)) crystalline phases of CBZ. However, conventional XRPD is insufficient for identifying and characterizing the internal structure of the non-crystalline sample, because its XRPD pattern is broad and fairly featureless (FIG. 1(b)). Based on this the XRPD pattern, it is not possible to characterize the non-crystalline sample as having local packing of the type seen in the beta or gamma forms, or some other form. Such a pattern generally results in a description of the sample in a non-specific way as “amorphous” or “x-ray amorphous”.

As proposed by Bates et. al. (7), the conventional XRPD data can be Fourier transformed to obtain the PDF following standard methods (5, 6). Column 2 (FIGS. 1(d)-1(f)) shows the PDF data obtained by Fourier transformation of the data collected using conventional XRPD. However, the Fourier transform does not increase the information content in the data, and it is still not possible to ascertain the local packing.

Column 3 (FIGS. 1(g)-1(i)) shows total scattering F(Q) determined from data collected at the synchrotron from samples prepared in the same way as the corresponding panels in the first column. There are significant differences between FIGS. 1(g) and 1(i), indicating that F(Q) is also a valuable function for differentiating between various crystalline forms of a molecular solid, just as conventional XRPD data are for crystalline samples, even though the total scattering data were measured with much lower Q-resolution. However, more importantly, the total scattering F(Q) of the non-crystalline sample, FIG. 1(h), when measured over a wide enough range of momentum transfer and properly normalized according to the method set forth above, is now rich in information compared to the conventional measurement (FIG. 1(b)). The high-Qₘₐₓ value of 20 Å¹ of the total scattering measurement corresponds to a real-space resolution of 0.16 Å.

The F(Q) plot of the non-crystalline sample with each of the crystalline phases can be compared. It is evident that the non-crystalline sample (FIG. 1(h)) much more closely resembles the beta-form (FIG. 1(g)) rather than the gamma form (FIG. 1(i)) in structure. Although the starting material for making the non-crystalline sample was CBZ in the gamma form, the non-crystalline sample clearly has packing more similar to the beta crystalline form than the gamma.

The same result can also be seen in the fourth column which shows the total scattering PDF, G(r), obtained by Fourier transforming the F(Q)'s in the third column. Column 4 (FIGS. 1(j)-1(l)) shows the PDF data obtained by Fourier transformation of the total scattering x-ray data. Here, it is perhaps even more clear that the non-crystalline sample (FIG. 1(k)) resembles beta form (FIG. 1(j)) in structure. There is a striking resemblance between the PDF of the beta crystalline material and the non-crystalline sample.

The correlations between PDFs in the range of r=3.0 Å-20 Å was studied. This range was chosen because the very local structure (i.e. r<3.0 Å) of all samples is the same. These are the intra-molecular pairs, for example, consisting of nearest and next-nearest neighbor carbon-carbon bonds at 1.4 Å and 2.4 Å, respectively. Comparisons of the total scattering PDFs in the range dominated by inter-molecular interactions, 3.0-20 Å, for the three samples (beta form, gamma form, and non-crystalline CBZ) using PolySNAP are shown below in Table 1.

TABLE 1
Correlation coefficients for the comparisons of total scattering
PDF data using PolySNAP over the range of r = 3.0-20 Å.

| | CBZ | CBZ | CBZ |
|---|---|---|---|
| | (beta form) | (gamma form) | (non-crystalline) |
| CBZ (beta form) | 1 | 0.45 | 0.84 |
| CBZ (gamma form) | | 1 | 0.61 |
| CBZ (non- | | | 1 |
| crystalline) | | | |

The results above indicate that the noncrystalline CBZ has local packing of the beta type. PolySNAP program uses a modified version of the Spearman correlation. Additionally, a different method of comparison, the Pearson product-momentum correlation, was used on the same data set. The following formula was used to calculate Pearson product-momentum correlation, R:

$$R = \frac{1}{1 - n} {\sum }_{i = 0}^{n} ( \frac{{X}_{i} - \overline{X}}{{σ}_{x}} ) ( \frac{{Y}_{i} - \overline{Y}}{{σ}_{y}} ) .$$

where X̅ and σₓ are the mean and standard deviation of a data set, respectively; Y̅ and σ_{y} are the mean and standard deviation of another data set, respectively; and n is the number of values in each data set. The Pearson product-momentum correlation analysis was implemented by a computer program. Comparisons of the total scattering PDFs in the range dominated by inter-molecular interactions, 3.0-20 Å, for the three samples (beta form, gamma form, and non-crystalline CBZ) using Pearson correlation are shown in Table 2.

TABLE 2
Correlation coefficients for the comparisons of total scattering
PDF data using Pearson correlation over the range of
r = 3.0-20 Å.

| | CBZ | CBZ | CBZ |
|---|---|---|---|
| | (beta form) | (gamma form) | (non-crystalline) |
| CBZ (beta form) | 1 | 0.580032 | 0.88121 |
| CBZ (gamma form) | | 1 | 0.721854 |
| CBZ (non- | | | 1 |
| crystalline) | | | |

The results obtained using Pearson product-momentum correlation agree with those obtained using PolySNAP.

Full-profile comparisons of the total scattering PDFs in the range dominated by inter-molecular interactions, 3-30 A, for the three samples (beta form, gamma form, and non-crystalline CBZ) using PolySNAP (21) yielded a correlation co-efficient of 0.8345 for the total scattering PDFs of the non-crystalline and beta crystalline forms (perfect match=1.0). The next closest similarity was observed for non-crystalline form of CBZ and the gamma form, but yielding a correlation coefficient of only 0.4701. Full-profile comparisons were also carried out using PolySNAP v.1.7.2 (21) over the range r 0.1-30 Å. Table 3 below shows the correlation coefficients for the profile comparisons.

TABLE 3
Correlation coefficients for the comparisons of total scattering
PDF data in PolySNAP over the range of r = 0.1-30 Å.

| | CBZ | CBZ | CBZ |
|---|---|---|---|
| 100K APS data | (beta form) | (gamma form) | (non-crystalline) |
| CBZ (beta form) | 1 | 0.5828 | 0.9005 |
| CBZ (gamma form) | | 1 | 0.6854 |
| CBZ (non- | | | 1 |
| crystalline) | | | |

Thus, analyzing the entire data range does not change the result significantly but reduces the sensitivity to finding differences in molecular packing of the correlation analysis by including a range of r that is highly similar regardless of the packing.

Accordingly, the results clearly demonstrate that whereas the conventional XRPD measurement is not sufficient for differentiating the internal structure of the non-crystalline sample, the total scattering measurement and the resulting PDF clearly show that the noncrystalline CBZ has local packing of the beta type.

### Example 3

### Identifying the Structure of a Non-Crystalline CBZ

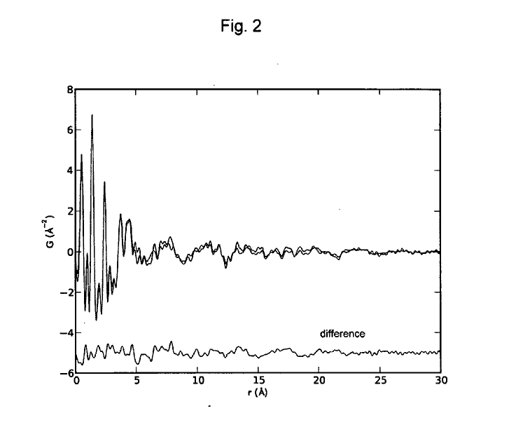

In FIG. 2, the agreement between the total-scattering PDFs of the bulk crystalline β-CBZ and the non-crystalline sample is shown. What is striking is that the features from the β-CBZ sample are qualitatively reproduced in the total scattering PDF of the non-crystalline sample over the whole range.

The figure was made in the following way. The total scattering PDF of the non-crystalline sample is exactly the same as that shown in FIG. 1(k) and is simply reproduced again in this figure (light grey). The total scattering PDF of the bulk β-CBZ sample is also based on that shown in FIG. 1(j); however, it has been modified before being plotted here (dark grey). It was modified by attenuating the PDF peaks to simulate the effects of the limited range of structural coherence. If the internal atomic arrangement of a nanoparticle resembles that of a bulk crystalline analog, its PDF resembles that of the crystalline material except that the amplitude of the PDF peaks is attenuated with increasing −r due to the loss of far-neighbor correlation outside the particle. This can be modeled by multiplying the crystalline PDF with the auto-correlation of the shape function of the particle. The shape function defines the shape of the nanoparticle and has value 1 inside the surface and value 0 outside the surface of the particle. For spherical particles the form of the autocorrelation function is, or PDF characteristic function (10), is as follows (11):

$$f ( r ; d ) = [ 1 - \frac{3 r}{2 d} + \frac{1}{2} {( \frac{r}{d} )}^{3} ] Φ ( d - r )$$

where d is the diameter of the spherical particle Φ(x) is a Heaviside step function that has value 1 in the region r≦d and value 0 for r>d. What was done here was to take the measured total scattering PDF of bulk crystalline β-CBZ and multiply that by the equation listed above, where d, the nanoparticle diameter, was varied by hand until reasonable agreement was obtained over the whole range of r, as shown in FIG. 2. This agreement was obtained when a nanoparticle diameter of 4.5 nm was used.

The excellent agreement between the attenuated PDF from the bulk crystal and the “amorphous” sample total scattering PDF is dramatic proof that the local packing in the non-crystalline sample, that cannot be characterized using regular laboratory XRPD, is of the β form with a range of structural coherence of 4.5 nm.

It is interesting to ask whether the sample is made up of discrete 4.5 nm nanocrystallites of the β form or whether it is truly a homogeneous amorphous structure with short-range molecular β-like packing. The data suggest the former because the sharpness of features in the total scattering PDFs is preserved with increasing r, whilst their amplitude is simply reduced, which is not the behavior seen in truly amorphous samples. Thus, the structure of the non-crystalline CBZ sample is actually nanocrystalline β form with an average particle diameter of 4.5 nm.

Although the total scattering PDF of the non-crystalline sample is well explained by bulk β form attenuated by the PDF characteristic function for a sphere, the possibility that the sample is a dispersion of nanoparticle sizes centered around the value of 4.5 nm cannot be ruled out. For example, narrow dispersions with ˜10% polydispersity are well explained using the characteristic function for a single sphere (12).

### Example 4

### Total Scattering and PDF Analysis of Indomethane (IND)

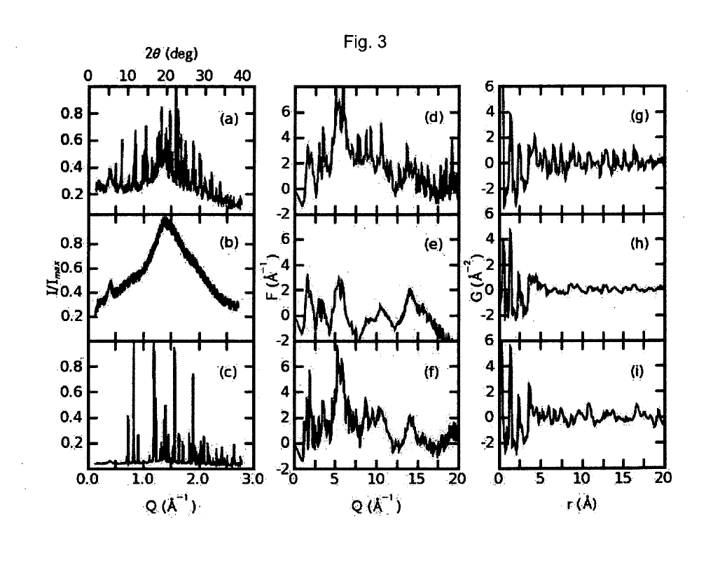

The results of total scattering analysis of IND is shown in FIG. 3. IND is a widely studied molecule that can also be found in the non-crystalline form. Again, in this case the conventional XRPD data show the non-crystalline sample to be x-ray amorphous but give no indication of the local structure. In contrast, the total scattering data are rich in structural information.

Interestingly, in this case the local structure of the non-crystalline sample is distinct from either of the two crystalline. samples that were measured. The local packing in the non-crystalline IND is neither the α nor the γ form but is distinct. The highest correlation coefficient from full-profile comparisons of the total scattering PDFs for melt-quenched, α and γ IND in PolySNAP was 0.6259, returned for the melt-quenched and a-IND phases. This is significantly lower than the highest value obtained for the CBZ total scattering PDF comparisons, with all other coefficients less than 0.5. When the comparison is performed over the range of r of 3.0-20 Å (shown in Table 4 below), the results are similar.

TABLE 4
Correlation coefficients for the comparisons of total scattering
PDF data using PolySNAP over the range of r = 3.0-20 Å.

| | IND | IND | IND |
|---|---|---|---|
| | (alpha form) | (gamma form) | (non-crystalline) |
| IND (alpha form) | 1 | 0.4075 | 0.6784 |
| IND (gamma form) | | 1 | 0.4911 |
| IND (non- | | | 1 |
| crystalline) | | | |

Additionally, Pearson correlation was performed over the range of r of 3.0-20 Å. The correlation coefficients are shown below in Table 5.

TABLE 5
Correlation coefficients for the comparisons of total scattering
PDF data using Pearson correlation over the range of
r = 3.0-20 Å.

| | IND | IND | IND |
|---|---|---|---|
| | (alpha form) | (gamma form) | (non-crystalline) |
| IND (alpha form) | 1 | 0.477629 | 0.706309 |
| IND (gamma form) | | 1 | 0.648231 |
| IND (non- | | | 1 |
| crystalline) | | | |

Thus, the total scattering PDFs indicate that the local structure of the melt-quenched IND sample at 100 K is largely distinct from the σ and γ crystalline forms. This contrasts with the suggestion based on crystallization and spectroscopic investigations that below Tg (315K) (22) amorphous IND has local structure, with dimeric hydrogen bonding, similar to the γ form (23). Linear combinations of the σ and γ crystalline phases did not give good agreement with the total scattering PDF from the non-crystalline sample. However, this result shows that distinct local molecular packing arrangements are possible in the non-crystalline phase, and that the total scattering PDF can characterize them. As with the non-crystalline CBZ sample, oscillations of the non-crystalline IND sample in the PDF are apparent over the whole r-range shown and clearly extend beyond 20 Å, which show that the non-crystalline IND sample is also nanocrystalline rather than truly amorphous.

These results have a number of important implications. First, total scattering using short wavelength x-rays produces data that can be used to differentiate different forms of amorphous or nanocrystalline organic material. Thus, an approach is described which can become a standard method for fingerprinting amorphous pharmaceuticals in much of the same way that conventional x-ray powder diffraction has become for crystalline powders. The present method of fingerprinting structural forms of amorphous and nanocrystalline drugs, as described supra, can greatly facilitate the commercialization of drugs in amorphous and nanocrystalline forms. It can also aid research into the amorphous and nanocrystalline forms of pharmaceuticals and other molecular solids because sufficient information exists in the total scattering signal to fit well-defined structural models for the molecular conformation and packing. This opens the door to future studies of things such as phase stability and the effects of process history on the form in non-crystalline organic material. For example, in the case of carbemazepine, the non-crystalline form studied here had β-packing, despite being derived from a γ-form precursor. Interestingly, on heating, the amorphous structure recrystallizes into γ-CBZ. Thus, x-ray total scattering analysis may help pharmaceutical scientists also find new crystalline polymorphs via an amorphous or nanocrystalline route.

### Example 5

### Stability Testing Of Drug

Drug A shows polymorphism. The desired form of Drug A is a nanocrystalline form (a). This nanocrystalline form and other forms of Drug A have different properties in terms of solubility, stability, and/or melting point. Because of these differences in properties, Drug A's safety, performance and/or efficacy are affected. Unfortunately, drug product performance testing, such as tests assessing the rate of dissolution, does not provide adequate control if polymorph ratio changes.

In conventional XRPD, α-nanocrystalline form of Drug A shows up as a broad featureless peak. In contrast, x-ray total scattering analysis of the α-nanocrystalline form of Drug A and the mathematical transformation of the data generated from such analysis show definite peaks and thus provides a fingerprint to identify this form of Drug A. Therefore, appropriate acceptance criteria, such as numerical limits for the position of the peaks, numerical ranges for the intensity of the peak, or other criteria may be specified.

Drug A in α-nanocrystalline form is subjected to a variety of environmental factors, such as temperature, humidity, and light, and then subjected to a variety of tests, including x-ray total scattering analysis, to examine how the quality of a drug substance or drug product varies with time under the influence of these environmental factors. From this information, especially data from x-ray total scattering analysis and the mathematical transformation of that data, the drug manufacturer can establish a retest period for the drug, or a shelf life for the drug product and recommended storage conditions.

Stability information gathered from x-ray total scattering analysis may be submitted to the FDA for the purposes of submitting an investigational new drug application. For example, 21 CFR 312.23 requires the reporting of chemistry, manufacturing, and control information. In each phase of the investigation, sufficient information is required to be submitted to assure the proper identification, quality, purity, and strength of the investigational drug. Stability data are required in all phases of the investigational new drug application to demonstrate that the new drug substance and drug product are within acceptable chemical and physical limits for the planned duration of the proposed clinical investigation.

Stability information gathered from x-ray total scattering analysis may also be submitted to the FDA for the purposes of application for FDA approval to market a new drug. For example, 21 CFR 314.50 requires “[a] full description of the drug substance including its physical and chemical characteristics and stability; and the specifications necessary to ensure the identity, strength, quality, and purity of the drug substance and the bioavailability of the drug products made from the substance, including, for example, tests, analytical procedures, and acceptance criteria relating to stability, sterility, particle size, and crystalline form.” X-ray total scattering analysis and the mathematical transformation of the data generated by such analysis are used to provide stability and acceptance criteria relating to Drug A in the nanocrystalline form for the approval process, while conventional x-ray powder diffraction techniques is not able to provide this information.

Furthermore, stability information gathered using x-ray total scattering analysis is submitted to the FDA and for the purposes of complying with good manufacturing practice for finished pharmaceuticals, for example, the requirements of 21 CFR 211.137 (expiration dating), 211.166 (stability test), 211.170 (testing of reserved samples), and 211.194 (maintenance of laboratory records, including stability test results).

### Example 6

### Manufacturing Process Control

Drug B shows polymorphism. The desired form of Drug B is a nanocrystalline form. The manufacturing process does not routinely give this nanocrystalline form of Drug B. This nanocrystalline form and other forms of Drug B have different property in terms of solubility, stability, and/or melting point. Because of these differences in properties, Drug B's safety, performance and/or efficacy are affected. Unfortunately, drug product performance testing, such as tests assessing the rate of dissolution, does not provide adequate control if polymorph ratio changes.

In conventional XRPD, the nanocrystalline form of Drug B shows up as a broad featureless peak. In contrast, x-ray total scattering analysis of the nanocrystalline form of Drug B and the mathematical transformation of the data generated from such analysis shows definite peaks and thus gives a fingerprint to identify this solid form of Drug B. Therefore, the manufacturer can specify appropriate acceptance criteria, such as numerical limits for the position of the peaks, numerical ranges for the intensity of the peak, or other criteria.

Representative samples of different batches of drug are tested, including x-ray total scattering, to determine the solid form. Batches that do not conform to the specification are rejected.

This information may be submitted to the FDA for the purposes of submitting an investigational new drug application, for example 21 CFR 312.23; for the purposes of application for FDA approval to market a new drug, for example, the requirements of 21 CFR 314.50(d)(1); and for the purposes of complying with good manufacturing practice for finished pharmaceuticals, for example, the requirements of 21 CFR 211.84, 211.110, 211.160, and 211.194.

### Example 7

### Submission of Patent Information

Drug C shows polymorphism. During research and development, the manufacturer of Drug C generates three nanocrystalline forms of Drug C. These particular nanocrystalline forms are only distinguishable by total scattering X-ray analysis and the mathematical transformation of data generated from such analysis, because all three forms show similar broad, featureless peaks in conventional XRPD. The manufacturer submits a new drug application with respect to Drug C in the α-nanocrystalline form. The manufacturer also has test data of Drug C (including those set forth in 21 CFR 314.53(b)(2)) in the β and γ-nanocrystalline forms. The test data demonstrate that a drug product containing the β-nanocrystalline form perform the same as the drug product described in the new drug application, but the γ-nanocrystalline form of Drug C does not. The manufacturer of Drug C has patented all three nanocrystalline forms of Drug C.

The manufacturer submits the patent information (which includes x-ray total scattering analysis of these nanocrystalline forms and/or the mathematical transformation of the data from such analysis) of both the α- and β-nanocrystalline forms of Drug C to the United States Food and Drug Administration (FDA). For example, this information may be submitted in compliance with the requirements of 21 CFR 314.53 for patents that claim a polymorph that is the same as the active ingredient described in the approved or pending application. The manufacturer certifies that it has test data, as set forth in 21 CFR 314.53(b)(2), demonstrating that a drug product containing the polymorph perform the same as the drug product described in the new drug application. Upon approval of Drug C in the α-nanocrystalline form, the patent information for both the α- and β-nanocrystalline forms of Drug C is listed in the Orange Book.

### Example 8

### Abbreviated New Drug Application

Section 505(j)(2) of the Federal Food, Drug, and Cosmetic Act (the “Act”) specifies that an Abbreviated New Drug Application (ANDA) must contain, among other things, information to show that the active ingredient in the generic drug product is the “same as” that of the Reference Listed Drug (RLD). Under section 505(j)(4) of the Act, FDA must approve an ANDA unless the agency finds, among other things, that the ANDA contains insufficient information to show that the active ingredient is the same as that in the RLD. FDA regulations implementing section 505(j) of the Act provide that an ANDA is suitable for consideration and approval if the generic drug product is the “same as” the RLD. Specifically, 21 CFR 314.92(a)(1) provides that the term “same as” means, among other things, “identical in active ingredient(s).” The drug substance in a generic drug product is considered to be the same as the drug substance in the RLD if it meets the same standards for identity. While using a drug substance polymorphic form that is different from that of the RLD may not preclude an ANDA applicant from formulating a generic drug product that exhibits bioequivalence and stability, the FDA recommends that ANDA applicants still consider the influence of polymorphic forms, because they affect bioavailability, bioequivalence, and stability.

A. Generic Drug with the Same Solid State Structure Form

Drug D exhibits polymorphism. Different polymorphs of Drug D exhibit different solubilities. The active ingredient of the final product is a nanocrystalline form of Drug D, which exhibits a broad featureless peak under conventional XRPD analysis. Generic manufacturer is able to make the same nanocrystalline form of Drug D, as determined by x-ray total scattering analysis and the mathematical transformation of the data generated from such analysis. The generic manufacturer submits an ANDA in accordance with 21 CFR 314.94. The ANDA contains, among other information, x-ray total scattering analysis of the proposed generic version of Drug D, demonstrating that the proposed generic has the same form as the approved form.

### B. Generic Drug with Different Solid State Structure Form

Drug E exhibits polymorphism. Different polymorphs of Drug E exhibit different solubilities. The α-crystalline and β-crystalline forms of Drug E are not highly soluble, as defined by Biopharmaceutics Classification System (BCS) criteria (not soluble in less than or equal to 250 ml water over a pH range of 1 to 7.5). The J3-nanocrystalline form of Drug E is more soluble than the crystalline forms, but still is not highly soluble, as defined by BCS criteria. The approved drug product contains the J3-nanocrystalline form of Drug E. Generic manufacturer is able to develop and manufacture an α-nanocrystalline form of Drug E and is able to show that the α-nanocrystalline form of Drug E is the same as the β-nanocrystalline form of Drug E in bioavailability and bioequivalence studies.

There is no polymorph specification in the United States Pharmacopeia (USP) (for example, melting point). There is sufficient concern that a polymorph specification in the drug product be established, and drug product performance testing (e.g., dissolution testing) does not provide adequate controls if the polymorph ratio changes. Thus, the generic manufacturer has to set specification with respect to the α-nanocrystalline form of Drug E. This information may be used for stability testing and manufacturing process control, as exemplified in Examples 5 and 6 above.

In conventional XRPD, both nanocrystalline forms of Drug E exhibit a broad featureless peak. X-ray total scattering analysis of the two nanocrystalline form of Drug E and the mathematical transformation of the data generated from such analysis show different peaks and thus give a fingerprint to identify these solid forms of Drug E. Therefore, the generic manufacturer can differentiate between the two nanocrystalline forms and specify appropriate acceptance criteria for the σ-nanocrystalline form of Drug E, such as numerical limits for the position of the peaks, numerical ranges for the intensity of the peaks, or other criteria.

Once an acceptance standard is specified, the generic manufacturer can conduct stability and manufacturing process controls as set forth in the above examples. This information is used by the generic manufacturer to the FDA in an ANDA, in compliance with the requirements 21 CFR 314.94. Among other information, 21 CFR 314.94 requires chemistry, manufacturing and control information, including requirements of 21 CFR 314.50(d)(1)(i), “[a] full description of the drug substance including its physical and chemical characteristics and stability; . . . the process controls used during manufacture and packaging; and the specifications necessary to ensure the identity, strength, quality, and purity of the drug substance and the bioavailability of the drug products made from the substance, including, for example, tests, analytical procedures, and acceptance criteria relating to stability, sterility, particle size, and crystalline form.” With data generated from x-ray total scattering analysis and mathematical transformations of such data, the manufacturer is able to comply with these FDA requirements.

### Example 9

### An Integrated System for Characterizing a Solid Small Molecule Organic Material

An integrated system for characterizing a solid small molecule organic material may be designed. This integrated system may be designed for fully automated measurement, analysis and reporting in an easy to use package suitable for a multi-disciplinary environment. Once the user of the system places a sample of a solid small molecule organic material into the appropriate chamber of the system and indicates to the system as such, the system will perform the x-ray total scattering analysis, collect the data generated thereby, and mathematically transform the generated data to provide a refined dataset. Depending on the user's preference, the generated data may be mathematically transformed to a reduced total scattering structure function, or an experimentally derived atomic pair distribution.

The system may have extensive uses in the pharmaceutical industry, especially drug development. It can be used to provide a unique profile (a “fingerprint”) for a drug or a drug product, whether such drugs or drug products are amorphous, crystalline, nanocrystalline, or distorted. The system may further be programmed to search for similar fingerprints in a library of fingerprints of known compounds so that the drug or drug products may be identified.

Furthermore, the system may be designed to meet the requirements of 21 CFR Part 11. Software may be installed such that the system can keep track of audit trail records. The audit trail records will be stored in a central server database and will always active and cannot be bypassed. Audit trail records will include the following information: application login/logoff, unauthorized attempts handling, start/stop instrument sessions, and new/changed electronic records. The audit trail record will further contain the following data, if applicable: event type, user ID, full (printed) user name, date/time, electronic record checksum, electronic record identification, additional data such as sample name and sample ID. Checksum algorithms, which detect accidental errors that may have been introduced during its transmission or storage, are known in the art. The reporting functionality of the audit trail software ensures reliable copying and readability by the FDA.

The claims are not to be limited in scope by the specific exemplary embodiments described herein. Indeed, various modifications of the invention in addition to those described herein will become apparent to those skilled in the art from the foregoing description and the accompanying figures. Such modifications are intended to fall within the scope of the appended claims.

What is claimed is:

1. A method of assessing stability of a chemical sample, the method comprising:
subjecting the chemical sample to x-ray total scattering analysis to create a first dataset;
storing or processing the chemical sample under at least one condition for a period of time;
subjecting the stored or processed chemical sample to x-ray total scattering analysis to create a second dataset; and
comparing the first dataset and the second dataset to assess the stability of the chemical sample.

2. The method of claim 1 wherein the stability is chemical stability of the sample molecules.

3. The method of claim 1, wherein the stability includes shelf life stability, phase stability, or process history stability.

4. The method of claim 1 wherein the first and second datasets are atomic pair distribution functions or mathematically related functions.

5. The method of claim 1 wherein the chemical sample comprises a distorted crystalline material or at least one crystalline phase.

6. The method of claim 1 wherein the chemical sample comprises an amorphous material or at least one amorphous phase.

7. The method of claim 1 wherein the chemical sample comprises a nanocrystalline material or at least one nanocrystalline phase.

8. The method of claim 1 wherein the first and second datasets are reduced structure functions.

9. The method of claim 1 wherein the chemical sample comprises multiple atomic structural phases.

10. The method of claim 8, wherein the multiple atomic structural phases include an amorphous phase and a crystalline phase.

11. The method of claim 1, wherein the at least one condition or the period of time is predetermined.

12. The method of claim 1 wherein the at least one condition comprises exposing the chemical sample to temperature, pressure, humidity, illumination, or atmospheric composition.

13. The method of claim 1 wherein period of time is twenty-four months.

14. The method of claim 13 wherein the period of time is three months.

15. The method of claim 1 wherein a change in the internal atomic structure of the chemical sample is determined by comparing the first and second datasets.

16. The method of claim 1, wherein the chemical sample is a drug, contrast agent or imaging agent.

17. The method of claim 1, wherein the chemical sample is a product comprising a drug, contrast agent, or imaging agent.

18. The method of claim 17, wherein the drug is a nanoscale drug, and further wherein the nanoscale drug is aripiprazole, salmeterol, salbutamol, fluticasone, or beclomethasone

19. The method of claim 17, wherein the product comprises a drug, and further wherein the product is a liquid, suspension, solution, gel, or powder.

20. A method of determining an internal structure of an organic sample, the method comprising:
subjecting the organic sample to x-ray total scattering analysis to define a first dataset; and
transforming the dataset by at least one of a reduced total scattering structure function F(Q), an experimentally derived atomic pair distribution function (PDF), or mathematically related functions; and
determining the internal structure of the organic sample by analyzing a second dataset from the F(Q), PDF, or mathematically related functions, wherein the x-ray total scattering analysis is conducted with a Qₘₐₓ greater than or equal to 5.0.

21. The method of claim 20, wherein the local atomic packing is fingerprinted by determining the internal structure of the organic sample.

22. The method of claim 20, wherein the organic sample is modeled by determining the internal structure.

23. The method of claim 20, further comprising determining a relative abundance of one or more structural phases of the internal structure of the organic sample.

24. The method of claim 23 wherein the one or more structural phases includes nanocrystalline, amorphous, crystalline, or distorted crystalline regions.

25. The method of claim 20, wherein the internal structure cannot be reliably determined by conventional XRPD techniques.

26. The method of claim 25, wherein the one or more structural phases cannot be reliably identified by conventional XRPD techniques.

27. The method of claim 20, wherein the organic sample is a dosage form, and further wherein the method detects variations in the dosage form.

28. A method of identifying components in a mixture, the method comprising:
subjecting the mixture to x-ray total scattering analysis to define a first dataset;
transforming the dataset to a reduced total scattering structure function F(Q), PDF or a mathematically related function; and
determining at least one component of the mixture by analysis of the dataset, and
analyzing the data set to identify any amorphous or nanocrystalline constituents in the mixture.

29. The method of claim 28, wherein the mixture is a pharmaceutical formulation.

30. The method of claim 28, wherein the pharmaceutical formulation comprises one or more drugs.

31. The method of claim 30, wherein the one or more drugs are dispersed in a polymer matrix.

32. The method of claim 28, wherein the mixture is a gel, liquid or suspension.

33. A method of assessing positional variations in structure or composition in a chemical sample comprising:
subjecting a first position of the chemical sample to x-ray total scattering to obtain a first dataset;
subjecting a second position of the chemical sample to x-ray total scattering to obtain a second dataset, wherein the first and second positions are different; and
comparing the first dataset and the second dataset to assess positional variations in the sample.

34. The method of claim 33, wherein the chemical sample remains intact during performance of the method.

35. The method of claim 33, wherein positional variations comprise variations in structural composition of the chemical sample.

36. The method of claim 330, wherein the method is capable of detecting an amorphous phase coexisting with a crystalline phase in the chemical sample.

37. The method of claim 33, wherein the method is capable of detecting trace amounts of an amorphous phase in the chemical sample.
